(19) United States
(12) Patent Application Publication
(10) Pub. No.: US 2013/0265243 A1
(43) Pub. Date: Oct. 10, 2013

(54) ADAPTIVE POWER ADJUSTMENT FOR A TOUCHSCREEN

(71) Applicant: Ho Kee Law, San Jose, CA (US)

(72) Inventor: Ho Kee Law, San Jose, CA (US)

(73) Assignee: MOTOROLA MOBILITY, INC., Libertyville, IL (US)

(21) Appl. No.: 13/443,299

(22) Filed: Apr. 10, 2012

(51) Int. Cl. G06F 3/041

(52) U.S. Cl. 345/173

(57) ABSTRACT

Adaptive power adjustment for a touch screen. A first level of voltage can be selectively applied to at least a first portion of a plurality of touch sensors of the touchscreen. A second level of voltage can be selectively applied to at least a second portion of the plurality of touch sensors, wherein the second level of voltage is lower than the first level of voltage and greater than 0 volts, or the second portion of the plurality of touch sensors can be deactivated.

### BACKGROUND OF THE INVENTION

1. Field of the Invention

The present invention generally relates to touchscreens and, more particularly, to controlling power consumed by touchscreens.

2. Background of the Invention

Touchscreens are used in many types of computing devices, for example smart phones, tablet computers, mobile computers (e.g., laptop computers), all-in-one computers and game consoles. Touchscreens also are sometimes integrated into displays of desktop computers and workstations.

A touchscreen is an electronic visual display configured to detect the presence and location of a touch within a display area. The term “touchscreen” generally refers to a display that receives tactile user inputs entered using one or more appendages, such as fingers or hands, but touchscreens also can sense touches from other devices, such as a stylus.

Touchscreens can be implemented using a variety of technologies. The most common are capacitive touchscreens and resistive touchscreens. A capacitive touchscreen detects surface capacitance or projected capacitance. Specifically, a capacitive touchscreen can produce an electrostatic field, and detect a distortion in the electrostatic field, measureable as a change in capacitance, due to the presence of an appendage or stylus. Various technologies are used to determine the location of the touch, usually via a controller.

A resistive touchscreen includes at least two electrically-resistive layers separated by a thin gap. When a user depresses an area of the touch screen using an appendage or stylus, the two electrically-resistive layers touch. A controller can determine the location of the touch by identifying a change in voltage measured where the layers touch.

### SUMMARY OF THE INVENTION

One or more embodiments disclosed within this specification relate to adaptive power adjustment for a touch screen.

An embodiment can include implementing voltage adjustment for a touchscreen. A first level of voltage can be selectively applied to at least a first portion of a plurality of touch sensors of the touchscreen. A second level of voltage can be selectively applied to at least a second portion of the plurality of touch sensors, wherein the second level of voltage is lower than the first level of voltage and greater than 0 volts.

Another embodiment also can include implementing voltage adjustment for a touchscreen. A user interface object visually presented by the touchscreen can be identified. Responsive to identifying the user interface object visually presented on the touchscreen, a first plurality of touch sensors configured to detect a touch event in a first region of the touchscreen where the user interface object is visually presented can be selectively activated. Responsive to identifying the user interface object visually presented on the touchscreen, a second plurality of touch sensors configured to detect a touch event in a second region of the touchscreen where the user interface object is not visually presented can be selectively deactivated.

Another embodiment also can include implementing voltage adjustment for a touchscreen. A first view of a first application presented by the touchscreen can be identified and, in response to identifying the first view, a first level of voltage can be applied to a plurality of touch sensors of the touchscreen. Further, a second view of a second application presented by the touchscreen can be identified and, in response to identifying the second view, a second level of voltage can be applied to the plurality of touch sensors of the touchscreen, wherein the second level of voltage is lower than the first level of voltage and greater than 0 volts.

These embodiments can include a method or a system configured to perform the various steps and/or functions described herein, or a computer program product including a computer-readable storage medium having computer-readable program code stored thereon that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a touchscreen system that is useful for understanding the present invention;

FIG. 2 depicts another arrangement of the touchscreen system of FIG. 1, which is useful for understanding the present invention;

FIG. 3 depicts another arrangement of the touchscreen system of FIG. 1, which is useful for understanding the present invention;

FIG. 4 is a flowchart presenting a method of implementing voltage adjustment for a touchscreen that is useful for understanding the present invention; and

FIG. 5 is a flowchart presenting another method of implementing voltage adjustment for a touchscreen that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Arrangements described herein relate to implementing voltage adjustment for a touchscreen. A first level of voltage can be selectively applied to at least a first portion of a plurality of touch sensors of the touchscreen. For example, the first portion of touch sensors can be sensors configured to detect a touch event in a first region of the touchscreen where a user interface object (hereinafter “object”) is visually presented. A second level of voltage can be selectively applied to at least a second portion of the plurality of touch sensors. For example, the second portion of touch sensors can be sensors configured to detect a touch event in other regions of the touchscreen where the object is not visually presented. Other objects may be presented in the other regions, but such objects may be objects that a user is less likely to select via a touch in comparison to the first object.

Since the user is less likely to touch the other regions of the touch screen in comparison to the first region, the touch sensitivity (or accuracy or resolution) in such other regions may not be as critical as the touch sensitivity (or accuracy or resolution) in the first region. Accordingly, the second level of voltage applied to those other can be lower than the first level of voltage, which may decrease the touch sensitivity (or accuracy or resolution) in the other regions, but can reduce the amount of power required to power the touch screen, which is advantageous to a device in which the touchscreen is incorporated, especially if the device is battery powered. In other words, the present arrangements can extend the battery live of such a device. Moreover, by applying a relatively high level of voltage to the first region, the touch sensitivity (or accuracy or resolution) in this region can be enhanced, thereby improving a user's experience interacting with the touchscreen.

As used herein, the term “user interface object” means a user dialog control, a button, a soft key, an icon, a scroll control, a menu, a picture, a drawing, or the like visually presented on a touchscreen in at least two-dimensions. A user interface object may be configured to initiate one or more programmatic actions when selected by a user via a touch event, though this need not be the case. Hereinafter a “user interface object” may be simply referred to as “object.” At least based on this definition and the description that follows, it will be understood by those skilled in the art that the term “object” as used hereinafter refers to a “user interface object.”

As used herein, a “touch event” is an event of an appendage of a person or a stylus touching a touchscreen. As such, a touch event is a user input. Non-limiting examples of touch events include, but are not limited to, a touch down event, a touch up event and a touch move event. An example of a touch down event is an appendage or stylus contacting the touchscreen. An example of a touch up event is an appendage or stylus being removed from the touchscreen. An example of a touch move event is an appendage or stylus being moved across the touchscreen.

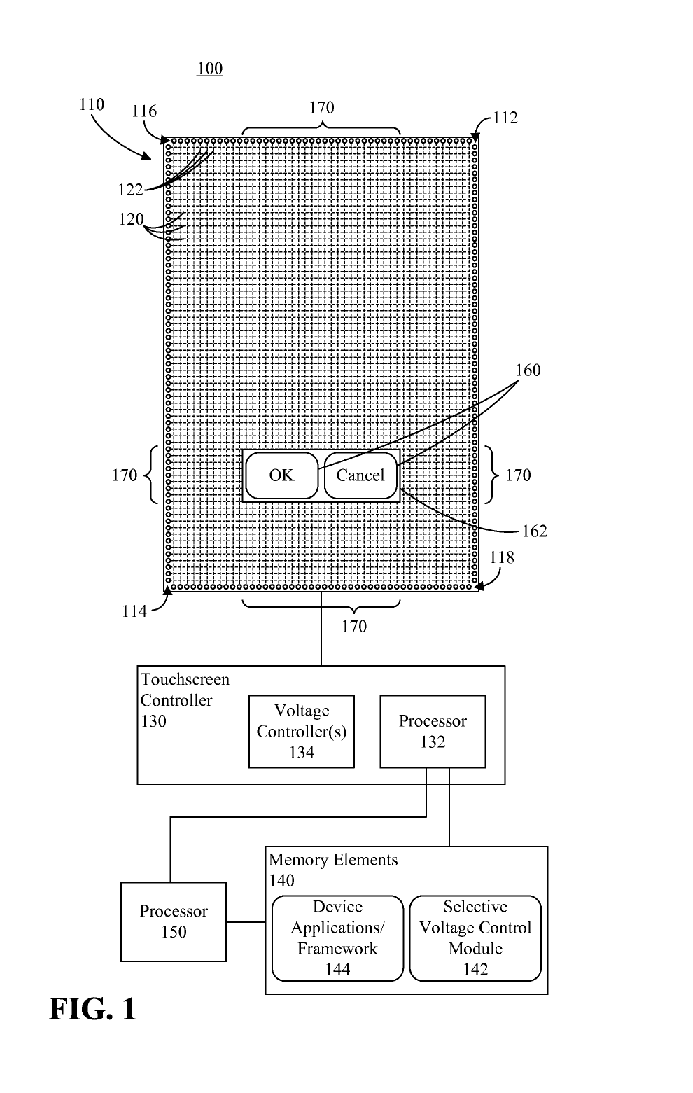

FIG. 1 depicts a touchscreen system (hereinafter “system”) 100 that is useful for understanding the present invention. The system can include a touchscreen 110 and a touchscreen controller 130. As used herein, the term “touchscreen” means an electronic visual display configured to detect the presence and location of a touch within a display area. The touchscreen 110 can be a capacitive touchscreen, a resistive touchscreen, or any other suitable type of touchscreen to which power is applied to detect touches. Such touchscreens are well known in the art. The touchscreen 110 can be a component of a smart phone, a tablet computer, a mobile computer (e.g., laptop computer), an all-in-one computer, a game console, or any other device that may include a touchscreen.

The touchscreen 110 can include a plurality of touch sensors 112, 114, 116, 118 positioned around a periphery of the touchscreen 110. The touch sensors 112-118 are configured to detect when and where the touchscreen 110 is touched, for example via a human appendage and/or a stylus, as is known to those skilled in the art. Electrical conductors (hereinafter “conductors”) 120 can electrically connect opposing ones of the touch sensors 112 and touch sensors 114. Similarly, electrical conductors 122 can electrically connect opposing ones of the touch sensors 116 and touch sensors 118. The conductors 120, 122 can be positioned on or near a front panel of the touchscreen 110 in a conventional manner. The conductors 120, 122 can be optically clear, or substantially optically clear, so as to not optically interfere with objects presented on the touchscreen 110. Such conductors are well known to those skilled in the art.

The touch sensors 112-118 can be electrically coupled to the touchscreen controller, for example via circuit traces or wires. The touchscreen controller 130 can selectively apply one or more levels of voltage to the touch sensors 112-118 to enable operability of the touch sensors 112-118. In illustration, the voltages applied to the touch sensors 112-118 can be coupled to the respective conductors 120, 122. The touch sensors 112-118 can detect a change in electrical current flowing through the respective conductors 120, 122, a change in voltage present on the respective conductors 120, 122 or a change in capacitance associated with the conductors 120, 122 in order to detect when and where a touch occurs on the touchscreen 110, as also is known in the art.

The touchscreen controller (hereinafter “controller’) 120 can include a processor 132. The processor can include, or be operatively coupled to, one or more of voltage controllers 134. The processor 132 can control the voltage controllers 134 to selectively apply voltage to the respective touch sensors 112-118. The processor 132 also can be configured to receive signals and/or data from the touch sensors 112-118, and process such signals/data, as will be further described herein.

The processor 132 further can be coupled to suitable memory elements 140 through a system bus or other suitable circuitry. The memory elements 140 can include one or more physical memory devices such as, for example, local memory and one or more bulk storage devices. Local memory refers to random access memory (RAM) or other non-persistent memory device(s) generally used during actual execution of the program code. Bulk storage device(s) can be implemented as a hard disk drive (HHD), a solid state drive (SSD), flash memory, or other persistent data storage device. The processor 132 also can include one or more cache memories (not shown) that provide temporary storage of at least some program code in order to reduce the number of times program code must be retrieved from local memory or a bulk storage device during execution.

As pictured in FIG. 1, the memory elements can store a selective voltage control module (or application) 142. The selective voltage control module 142, being implemented in the form of executable program code, can be executed by the processor 132 and, as such, can be considered part of the system 100. In an arrangement in which the memory elements 140 are shared with other system devices, the memory elements 140 further can store additional modules and/or applications. In illustration, the memory elements 140 can store device applications and/or framework 144 executed by a device in which the system 100 is implemented. In one arrangement, such applications and/or framework 144 can be executed by another device processor 150, which can be communicatively linked to the processor 132, for example via a system bus. In another arrangement, the processor 132 further can be configured to execute the applications and/or framework 144.

A framework can provide one or more application programming interfaces (APIs), which can provide data to the selective voltage control module 142 related to the applications being executed by the processor 150 based on the context of the applications or the context of objects being presented by the applications on the touchscreen 110. In another arrangement, the applications can be configured to provide such data. The selective voltage control module 142 can process the data to determine when and where on the touchscreen 110 high sensitivity (or accuracy or resolution) to touch events is warranted, and when and where on the touchscreen 110 a lower sensitivity (or accuracy or resolution) to touch events may be tolerated. Moreover, based on such data, the selective voltage control module 142 can determine that sensitivity (or accuracy or resolution) to touch events can be deactivated for certain areas of the touchscreen 110, or even the entire touchscreen if touch events are not expected when a particular view is presented on the touchscreen 110. In this regard, the selective voltage control module 142 can dynamically control touch sensitivity (or accuracy or resolution) on the touchscreen in order to reduce power consumption by the touchscreen 110 and/or the processor 132, while still providing a high quality user experience.

In operation, the processor 132 can execute the selective voltage control module 142 to selectively apply voltage to the touch sensors 112-118. Based on execution of the device applications/framework 144, either by the processor 132 or the processor 150, the processor 132 can identify a region 162 of the touchscreen 110 that a user is likely to touch. The region 162 can be, for example, a region of the touchscreen 110 in which one or more objects 160 are presented. In this regard, dimensions of the first region can be approximately equal to dimensions of the object(s) 160. Moreover, the dimensions can be substantially rectangular, circular or square, but this need not be the case. Indeed, the dimensions can be defined by complex shapes, and the invention is not limited in this regard. The processor 132 can identify the object(s) 160, and based on the size/dimensions of the object(s) 160 and location of the object(s) 160 on the touchscreen 110, identify one or more regions 162. If the processor 150 executes the device applications/framework 144, the processor can communicate data to the processor 132 indicating the size/dimensions and location the object(s) 160. If the processor 132 the device applications/framework 144, the processor can determine the data based upon such execution.

In response to identifying the object(s) 160 presented on the touchscreen 110, via the voltage controller 134, the processor 132 can selectively apply a first level of voltage to touch sensors 170 configured to detect a touch event in the region 162 of the touchscreen 110 where the object(s) 160 is/are visually presented. The processor 132 can apply a second level of voltage to the touch sensors 112-118 (excluding the touch sensors 170) configured to detect a touch event in one or more other regions of the touchscreen where the object(s) 160 is/are not visually presented. The level of the second voltage can be lower than the level of the first voltage, but greater than 0 volts. In another arrangement, voltage can be removed from the touch sensors 112-118 (excluding the touch sensors 170). In the case that the voltage is removed from the touch sensors 112-118 (excluding the touch sensors 170) the touch sensors 112-118 (excluding the touch sensors 170) can be deactivated. Regardless of whether the level of the second voltage is lower than the level of the first voltage, or the voltage is removed from the touch sensors 112-118 (excluding the touch sensors 170), the power required to operate the touchscreen 110 can be reduced, while still providing high sensitivity (or accuracy or resolution) in the region 162 where the user is likely to touch the touch screen.

In one non-limiting arrangement, selective ones of the touch sensors 112-118 (excluding the touch sensors 170), can be selectively disabled. For example, every other one, every third one, every fourth one, etc. of the touch sensors 112-118 (excluding the touch sensors 170) can be selectively disabled. Accordingly, the power consumed by the touchscreen while the touch screen still may detect touches in other regions of the touch screen 110 where the images 160 are not presented.

In one non-limiting arrangement, prior to presentation of the object(s) 160, a third intermediate level of voltage can be applied to each of the touch sensors 112-118. The intermediate level of voltage can be less than the first level of voltage, but greater than the second level of voltage. The intermediate level of voltage can be applied to each of the touch sensors 112-118 when the selective voltage control module 142 is agnostic to whether certain regions of the touchscreen 110 should be provided high touch event sensitivity (or accuracy or resolution) and whether it is suitable for certain regions of the touchscreen 110 to be provided reduced touch event sensitivity (or accuracy or resolution). Further, in lieu of, or in addition to, the intermediate level of voltage being applied to each of the touch sensors 112-118 every other one, every third one, every fourth one, etc. of the touch sensors 112-118 can be selectively disabled.

Further, a detection rate (e.g., sampling rate) of the touch sensors 112-118 can be selectively controlled by controlling a clock frequency applied to sensor data collection by the touch sensors 112-118 and/or to processing data from the touch sensors 112-118, for example by the processor 132. For example, if the objects 160 represent user dialog buttons, a higher level of latency for processing touch events may be acceptable in comparison to objects that are user manipulated in a game. Accordingly, the clock frequency applied to the touch sensors 112-118 can be reduced, thereby reducing power consumed by the system 100. Moreover, if only touch up or touch down events are to be detected, it may be unlikely that the objects 160 will be moved by a user. Accordingly, a clock frequency applied to touch move data generation and/or processing can be reduced, thus further reducing the power consumed.

Reducing the clock rate(s) can result in increased latency, which may create choppiness in the movement of an object 260 if the object 260 is moved while the reduced clock rates are applied. To reduce such choppiness, artificial touch move event data can be generated by interpolating touch move event data that is captured. Specifically, the data can be interpolated to estimate positions of the object 260 on the touchscreen at positions corresponding to the captured touch move event data. Other touch event information also can be interpolated in a similar manner to improve the user experience while the lower clock rate(s) are applied.

If a view presented on the touchscreen changes, and thus further touch events may occur, such as moving objects or scrolling, or an application is executing which will benefit from lower latency of touch responses, a clock frequency applied to the detection rate of the touch sensors 112-118 and/or a clock frequency applied to processing data from the touch sensors 112-118 can be selectively increased to decrease the latency of processing touch events.

In one arrangement, the touch sensors 170 can be configured to exclusively detect a change in current through their respective conductors 120, 122. Thus, the touch sensors need not detect a change in voltage or change in capacitance, which can further decrease power consumed by the touchscreen. If the touch sensors 112-118 (excluding the touch sensors 170) are not deactivated, such touch sensors also can be configured to detect a change in current through their respective conductors 120, 122.

Configuring the touch sensors 112-118 to exclusively detect a change in current through their respective conductors 120, 122 also can be applied to compensate for faulty components, such as the touch sensors 112-118. For example, the selective voltage control module 142 can be configured to process touch events and identify regions of the touchscreen 110 that do not appear to be properly detecting touch events (e.g., low expected accuracy) or regions determined to be noisy.

A region can be determined to have low expected accuracy by the selective voltage control module 142 based on statistics related to touch events detected in the region. For example, if a high level of latency (unrelated to a reduction in rate) is generally encountered in a particular region, this could be due to some touch events not being detected, and the user must touch the region more than once for the touch event to be detected. Such region can be identified as having a low expected accuracy rate. A region in which a large variation in touch events are identified can be considered noisy. For example, when the statistics indicate that multiple touch events oftentimes are detected when only one touch event is expected, this can indicate that the region is noisy.

The touch sensors 112-118 that detect touch events in regions that are noisy or have low expected accuracy can be configured to exclusively detect changes in current. Moreover, the steady state current through the respective conductors 120, 122 can be selectively increased, for example by applying increased voltage to their respective touch sensors 112-118. Increasing the steady state current can increase the signal-to-noise (SNR) ratio between touch events and background noise, as well as improve touch sensitivity (or accuracy or resolution), and thus accuracy, both of which can improve detection of the touch events.

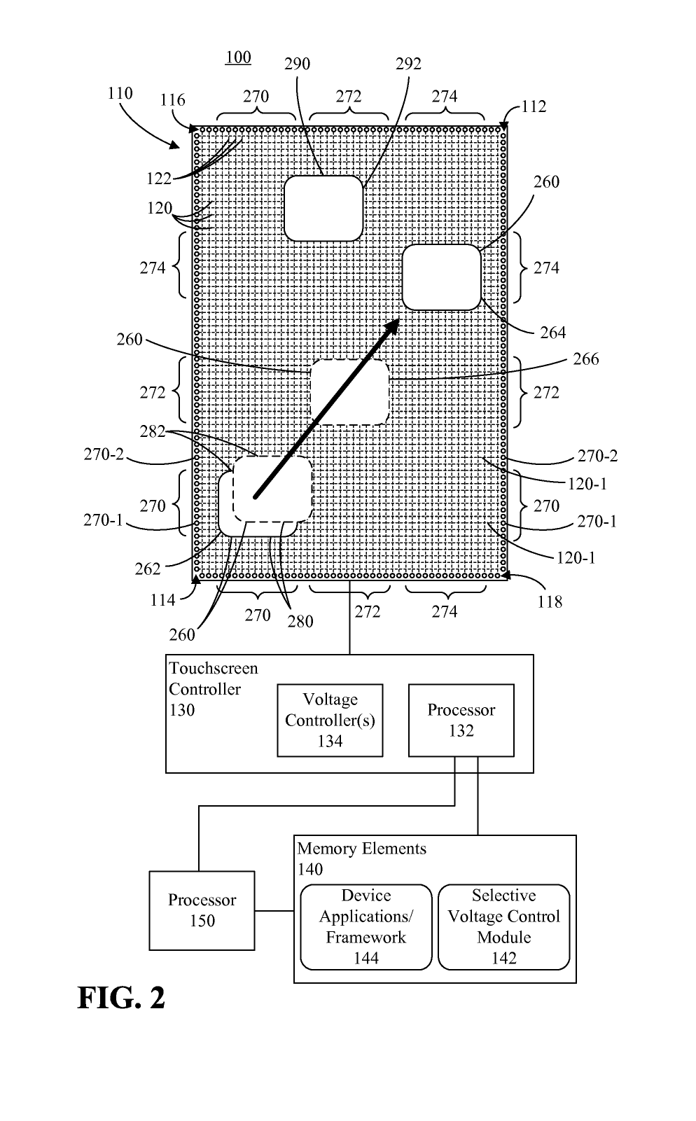

FIG. 2 depicts another arrangement of the touchscreen system 100 of FIG. 1, which is useful for understanding the present invention. FIG. 2 depicts the object 260 being moved up and to the right from its original location. When a touch move event is detected to move the object 260 from the region 262 to another region 264 of the touchscreen 110, the processor can dynamically adjust the level of voltage applied to the touch sensors 112-118 as the object 160 is moved. In illustration, as the object 260 is moved from the region 262, the level of voltage applied to the touch sensors 270 can be selectively reduced in a sequential manner, or the touch sensors 270 can be deactivated in a sequential manner.

In the vertical direction, when a lower portion 280 of the object 260 moves beyond the conductor 120-1 associated with the touch sensors 270-1, such touch sensors 270-1 can be deactivated or the voltage applied to the sensors 270-1 can be reduced to a voltage level less than the first voltage level but greater than 0 volts. When an upper portion 282 of the object 260 moves past the conductor 120-2 associated with the touch sensors 270-2, the sensors 270-2 can be activated or a level of voltage applied to the sensors 270-2 can be increased. A similar process can be implemented for the horizontal component of the object movement.

While the object 260 is being moved from the region 262 to the region 264, at some point in time, even perhaps momentarily, the object 260 may be present in a region 266 of the touchscreen. At this time, the touch sensors 272 that detect touch events in the region 266 can be provided the first level of voltage, while other touch sensors 112-118 (exclusive of the touch sensors 272) can be provided a second, lower, level of voltage, or can be deactivated.

When the object is located in the region 264, the touch sensors 274 that detect touch events in the region 264 can be provided the first level of voltage, while other touch sensors 112-118 (exclusive of the touch sensors 274) can be provided a second, lower, level of voltage, or can be deactivated. By this time, the voltage applied to the touch sensors 270, 272 can be at the second voltage level or deactivated. Accordingly, the touch sensors 112-118 can be dynamically controlled to provide high touch sensitivity (or accuracy or resolution) exclusively where the object 260 is presently located at any particular moment in time, and provide low or no sensitivity (or accuracy or resolution) where the object is not presently located.

In another arrangement, the selective voltage control module 142 can determine whether it is likely that the object 260 will be moved, for example by receiving data from the device applications/framework 144 indicating that the object may be moved by a user and/or identifying statistical information indicating the likelihood of the object 260 being moved. If it is likely that the object may be moved, or if the object 260 may be moved, the processor 132 can apply the first level of voltage to each of the touch sensors 112-118. If, however, it is unlikely that the object may be moved, the processor 132 can apply the first level of voltage to the touch sensors 270 that detect touch events in the region 262 where the object is located, and the second level of voltage can be applied the other touch sensors 112-118 (exclusive of the sensors 270) or the other touch sensors 112-118 can be deactivated.

A plurality of objects can be presented on the touchscreen 110 and located in different regions of the touchscreen 110. For example, an object 290 also can be presented on the touchscreen 110. The first level of voltage also can be selectively applied to touch sensors 112-118 configured to detect touch in the region 292 of the touchscreen 110 where the object 290 is located. In another arrangement, the selective voltage control module 142 can determine, for example based on data generated by execution of the device applications/framework 144, that the object 290 does not warrant high sensitivity (or accuracy or resolution) to touch events. Accordingly, the second level of voltage can be applied to touch sensors 112-118 configured to detect a touch event in the region 292, or such touch sensors can be deactivated.

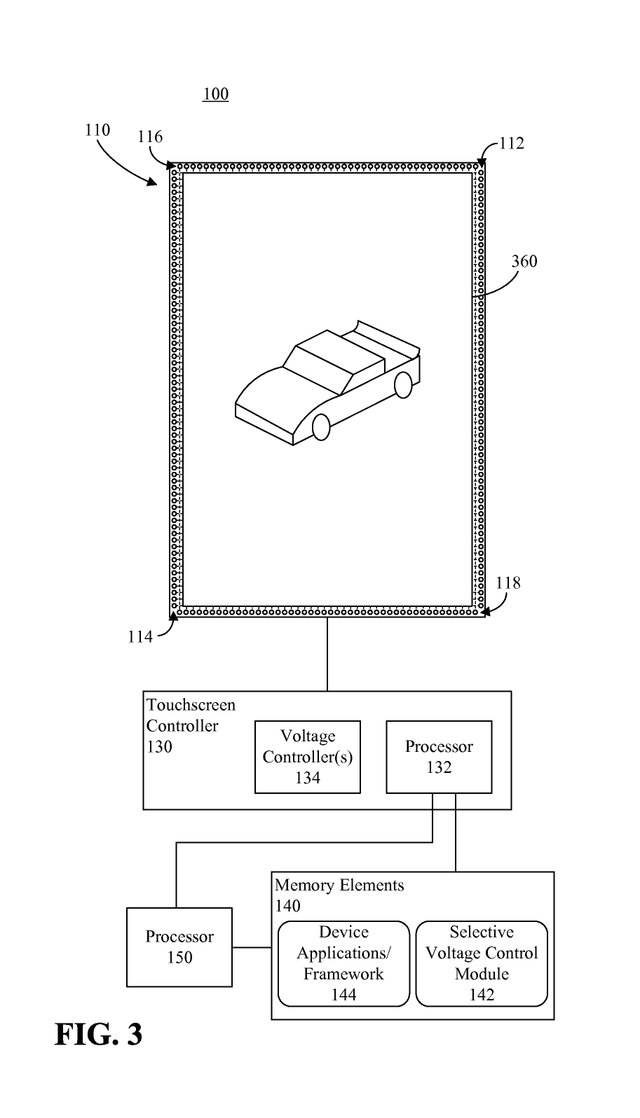

FIG. 3 depicts another arrangement of the touchscreen system 100 of FIG. 1, which is useful for understanding the present invention. In this arrangement, the selective voltage control module 142 can identify a type of application being executed by the processor 150 and/or the processor 132, and selectively determine the level of voltage to apply to the touch sensors 112-118 based on the type of application. For example, if a view of a gaming application 360 is presented on the touchscreen 110, the first level of voltage can be applied to each of the touch sensors 112-118, thereby providing high touch sensitivity (or accuracy or resolution) while the user is playing the game. Further, one or more clock rates applied to the touch sensors 112-118 and/or processor 132 for detecting and/or processing touch events can be increased, for example as previously described. This arrangement is not limited to gaming applications, and also can be implemented for computer aided design (CAD) applications, drawing applications, paint applications, or any other applications that will provide a noticeably enhanced user experience when high touch sensitivity (or accuracy or resolution) settings are applied.

When, however, the application 360 is minimized or closed, the second (low) level of voltage greater than 0 volts, or the third (intermediate) level of voltage greater than the second voltage, can be applied to each of the touch sensors 112-118 to reduce power consumption of the system. In addition to, or in lieu of the second or third level of voltage being applied, every other one, every third one, every fourth one, etc. of the touch sensors 112-118 can be selectively disabled.

Further, one or more clock rates applied to the touch sensors 112-118 and/or processor 132 for detecting and/or processing touch events can be decreased, for example as previously described, thus providing further power savings. If a view of another application (not shown) is presented on the touchscreen 110, but the selective voltage control module 142 determines that the application does not require high touch sensitivity (or accuracy or resolution), the voltage applied to each of the touch sensors 112-118 can remain at the second or third level and/or the clock rates can remain at the reduced level.

In some instances, a view may be presented on the touchscreen 110 which does not include objects that are user selectable. When such a view is presented, each of the touch sensors 112-118 can be deactivated.

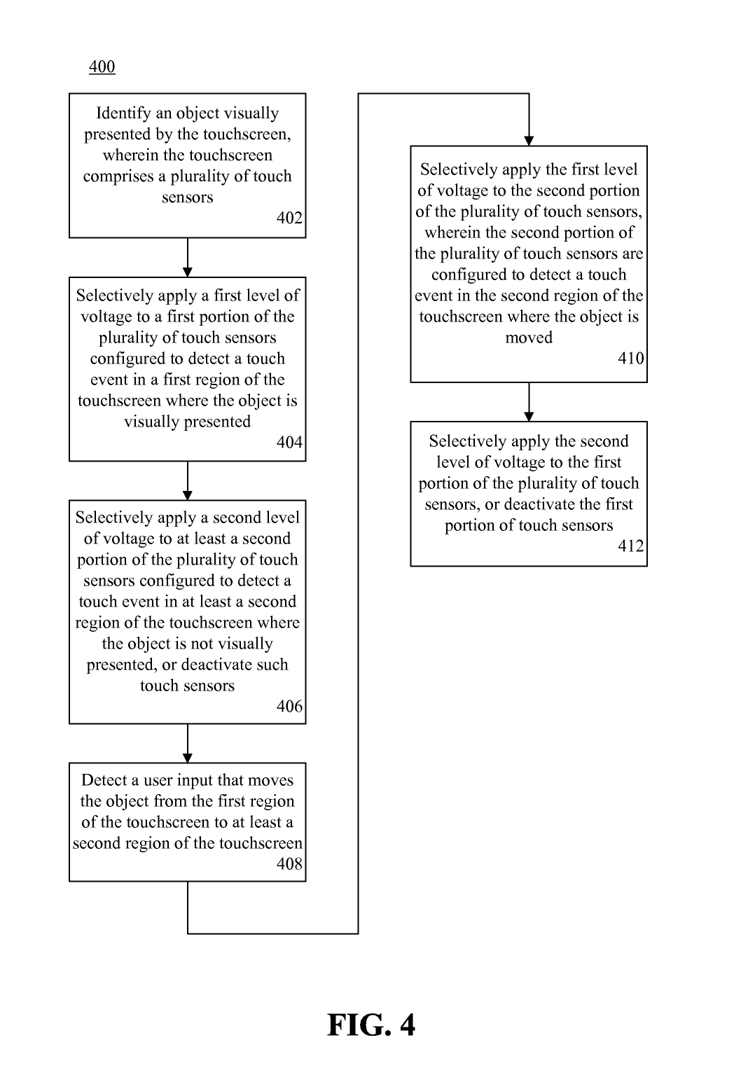

FIG. 4 is a flowchart presenting a method 400 of implementing voltage adjustment for a touchscreen that is useful for understanding the present invention. At step 402, an object visually presented by the touchscreen can be identified, wherein the touchscreen comprises a plurality of touch sensors. At step 404, a first level of voltage can be selectively applied to a first portion of the plurality of touch sensors configured to detect a touch event in a first region of the touchscreen where the object is visually presented. At step 406, a second level of voltage can be selectively applied to at least a second portion of the plurality of touch sensors configured to detect a touch event in at least a second region of the touchscreen where the object is not visually presented, or such touch sensors can be deactivated.

At step 408, a user input that moves the object from the first region of the touchscreen to at least a second region of the touchscreen can be detected. At step 410, the first level of voltage can be selectively applied to the second portion of the plurality of touch sensors, wherein the second portion of the plurality of touch sensors are configured to detect a touch event in the second region of the touchscreen where the object is moved. At step 412, the second level of voltage can be applied to the first portion of the plurality of touch sensors, or the first portion of touch sensors can be deactivated.

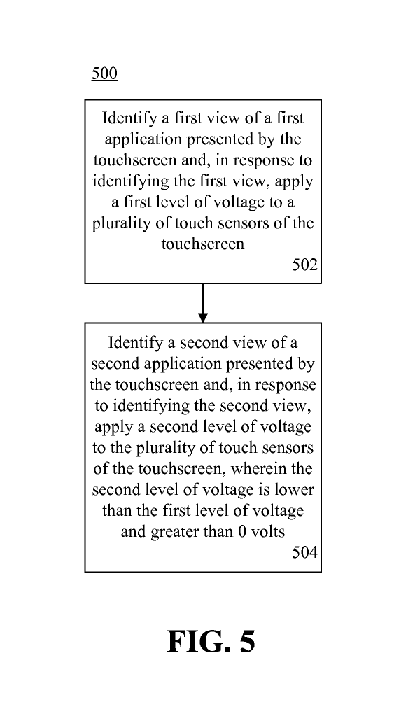

FIG. 5 is a flowchart presenting another method 500 of implementing voltage adjustment for a touchscreen that is useful for understanding the present invention. At step 502, a first view of a first application presented by the touchscreen can be identified. In response to identifying the first view, a first level of voltage can be applied to a plurality of touch sensors of the touchscreen. At step 504, a second view of a second application presented by the touchscreen can be identified and, in response to identifying the second view, a second level of voltage can be applied to the plurality of touch sensors of the touchscreen, wherein the second level of voltage is lower than the first level of voltage and greater than 0 volts.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-readable (or computer-usable) program code that, when being loaded and executed by one or more processors, controls the processing system such that it carries out the methods described herein. The present invention also can be embedded in a computer program product comprising a non-transitory computer-readable storage medium, readable by a machine, tangibly embodying a program of instructions executable by the processing system to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one level of voltage, touch sensor, object, region, portion or the like from another message, signal, item, object, device, system, apparatus, step, process, or the like. Thus, an ordinal term used herein need not indicate a specific position in an ordinal series. For example, a process identified as a “second touch sensor” may occur before a touch sensor identified as a “first touch sensor.” Further, one or more processes may occur between a first process and a second process.

This invention can be embodied in other forms without departing from the spirit or essential attributes thereof. Accordingly, reference should be made to the following claims, rather than to the foregoing specification, as indicating the scope of the invention.

What is claimed is:

1. A method of implementing voltage adjustment for a touchscreen, comprising:
selectively applying a first level of voltage to at least a first portion of a plurality of touch sensors of the touchscreen; and
selectively applying a second level of voltage to at least a second portion of the plurality of touch sensors, wherein the second level of voltage is lower than the first level of voltage and greater than 0 volts.

2. The method of claim 1, further comprising:
identifying a user interface object visually presented by the touchscreen;
wherein selectively applying the first level of voltage to the first portion of the plurality of touch sensors comprises:
responsive to identifying the user interface object visually presented on the touchscreen, selectively applying the first level of voltage to touch sensors configured to detect a touch event in a first region of the touchscreen where the user interface object is visually presented; and
wherein selectively applying the second level of voltage to at least the second portion of the plurality of touch sensors comprises:
responsive to identifying the user interface object visually presented on the touchscreen, selectively applying the second level of voltage to touch sensors configured to detect a touch event in at least a second region of the touchscreen where the user interface object is not visually presented.

3. The method of claim 2, further comprising:
detecting a user input that moves the user interface object from the first region of the touchscreen to at least a second region of the touchscreen; and
responsive to detecting the user input:
selectively applying the first level of voltage to the second portion of the plurality of touch sensors, wherein the second portion of the plurality of touch sensors are configured to detect a touch event in the second region of the touchscreen where the user interface object is moved; and
selectively applying the second level of voltage to the first portion of the plurality of touch sensors, wherein the first portion of the plurality of touch sensors are configured to detect a touch event in the first region of the touchscreen from which the user interface object is moved.

4. The method of claim 3, further comprising:
responsive to detecting the user input:
selectively applying the first level of voltage to at least a third portion of the plurality of touch sensors, wherein the third portion of the plurality of touch sensors are configured to detect a touch event in a third region of the touchscreen through which the user interface object is moved, and the first level of voltage is selectively applied to the third portion of the plurality of touch sensors only when the user interface object is presented within the third region of the touchscreen; and
selectively applying the second level of voltage to the third portion of the plurality of touch sensors when the user interface object no longer is presented within the third region of the touchscreen.

5. The method of claim 2, wherein dimensions of the first region of the touchscreen are approximately equal to dimensions of the user interface object.

6. The method of claim 2, further comprising:
determining whether it is likely that a user will move the user interface object visually presented on the touchscreen; and
responsive to determining that it is unlikely that the user will move the user interface object, selectively reducing a touch detection rate for data generated by the second portion of the plurality of touch sensors of the touchscreen.

7. The method of claim 1, further comprising:
identifying a plurality of user interface objects visually presented by the touchscreen;
wherein selectively applying the first level of voltage to at least the first portion of the plurality of touch sensors comprises:
responsive to identifying the plurality of user interface objects visually presented on the touchscreen, selectively applying the first level of voltage to touch sensors configured to detect a touch event in a plurality of first regions of the touchscreen, wherein at least one of the plurality of the user interface objects is visually presented in each of the first regions; and
wherein selectively applying the second level of voltage to at least the second portion of the plurality of touch sensors comprises:
responsive to identifying the plurality of user interface objects visually presented on the touchscreen, selectively applying the second level of voltage to touch sensors configured to detect a touch event in at least a second region of the touchscreen where the user interface objects are not visually presented.

8. The method of claim 1, further comprising:
identifying a dialog button visually presented in a first region of the touchscreen;
selectively configuring touch sensors configured to detect touch in the first region to exclusively detect a change in current through the first region, wherein the touch sensors configured to detect touch in the first region are selected from a group of touch sensors consisting of the first portion of the plurality of touch sensors and the second portion of the plurality of touch sensors.

9. The method of claim 1, further comprising:
selectively disabling at least a third portion of the plurality of touch sensors.

10. A method of implementing voltage adjustment for a touchscreen, comprising:
identifying a user interface object visually presented by the touchscreen;
responsive to identifying the user interface object visually presented on the touchscreen:
selectively activating a first plurality of touch sensors configured to detect a touch event in a first region of the touchscreen where the user interface object is visually presented; and
responsive to identifying the user interface object visually presented on the touchscreen, selectively deactivating a second plurality of touch sensors configured to detect a touch event in a second region of the touchscreen where the user interface object is not visually presented.

11. The method of claim 10, further comprising:
detecting a user input that moves the user interface object from the first region of the touchscreen to at least a second region of the touchscreen; and
responsive to detecting the user input:
selectively activating the second portion of the plurality of touch sensors, wherein the second portion of the plurality of touch sensors are configured to detect a touch event in the second region of the touchscreen where the user interface object is moved; and
selectively deactivating to the first portion of the plurality of touch sensors, wherein the first portion of the plurality of touch sensors are configured to detect a touch event in the first region of the touchscreen from which the user interface object is moved.

12. A method of implementing voltage adjustment for a touchscreen, comprising:
identifying a first view of a first application presented by the touchscreen and, in response to identifying the first view, applying a first level of voltage to a plurality of touch sensors of the touchscreen; and
identifying a second view of a second application presented by the touchscreen and, in response to identifying the second view, applying a second level of voltage to the plurality of touch sensors of the touchscreen, wherein the second level of voltage is lower than the first level of voltage and greater than 0 volts.

13. The method of claim 12, further comprising:
in response to identifying the first view, applying a first level of touch detection rate to the plurality of touch sensors of the touchscreen; and
in response to identifying the second view, applying a second level of touch detection rate to the plurality of touch sensors of the touchscreen, wherein the second level of touch detection rate is lower than the first level of touch detection rate.

14. A system comprising:
a touchscreen controller configured to initiate executable operations comprising:
selectively applying a first level of voltage to at least a first portion of a plurality of touch sensors of the touchscreen; and
selectively applying a second level of voltage to at least a second portion of the plurality of touch sensors, wherein the second level of voltage is lower than the first level of voltage and greater than 0 volts.

15. The system of claim 14, wherein the touchscreen controller further is configured to initiate executable operations comprising:
identifying a user interface object visually presented by the touchscreen;
wherein selectively applying the first level of voltage to the first portion of the plurality of touch sensors comprises:
responsive to identifying the user interface object visually presented on the touchscreen, selectively applying the first level of voltage to touch sensors configured to detect a touch event in a first region of the touchscreen where the user interface object is visually presented; and
wherein selectively applying the second level of voltage to at least the second portion of the plurality of touch sensors comprises:
responsive to identifying the user interface object visually presented on the touchscreen, selectively applying the second level of voltage to touch sensors configured to detect a touch event in at least a second region of the touchscreen where the user interface object is not visually presented.

16. The system of claim 15, wherein the touchscreen controller further is configured to initiate executable operations comprising:
detecting a user input that moves the user interface object from the first region of the touchscreen to at least a second region of the touchscreen; and
responsive to detecting the user input:
selectively applying the first level of voltage to the second portion of the plurality of touch sensors, wherein the second portion of the plurality of touch sensors are configured to detect a touch event in the second region of the touchscreen where the user interface object is moved; and
selectively applying the second level of voltage to the first portion of the plurality of touch sensors, wherein the first portion of the plurality of touch sensors are configured to detect a touch event in the first region of the touchscreen from which the user interface object is moved.

17. The system of claim 16, wherein the touchscreen controller further is configured to initiate executable operations comprising:
responsive to detecting the user input:
selectively applying the first level of voltage to at least a third portion of the plurality of touch sensors, wherein the third portion of the plurality of touch sensors are configured to detect a touch event in a third region of the touchscreen through which the user interface object is moved, and the first level of voltage is selectively applied to the third portion of the plurality of touch sensors only when the user interface object is presented within the third region of the touchscreen; and
selectively applying the second level of voltage to the third portion of the plurality of touch sensors when the user interface object no longer is presented within the third region of the touchscreen.

18. The system of claim 15, wherein dimensions of the first region of the touchscreen are approximately equal to dimensions of the user interface object.

19. The system of claim 15, wherein the touchscreen controller further is configured to initiate executable operations comprising:
determining whether it is likely that a user will move the user interface object visually presented on the touchscreen; and
responsive to determining that it is unlikely that the user will move the user interface object, selectively reducing a touch detection rate for data generated by the second portion of the plurality of touch sensors of the touchscreen.

20. The system of claim 14, wherein the touchscreen controller further is configured to initiate executable operations comprising:
identifying a plurality of user interface objects visually presented by the touchscreen;
wherein selectively applying the first level of voltage to at least the first portion of the plurality of touch sensors comprises:
responsive to identifying the plurality of user interface objects visually presented on the touchscreen, selectively applying the first level of voltage to touch sensors configured to detect a touch event in a plurality of first regions of the touchscreen, wherein at least one of the plurality of the user interface objects is visually presented in each of the first regions; and
wherein selectively applying the second level of voltage to at least the second portion of the plurality of touch sensors comprises:
responsive to identifying the plurality of user interface objects visually presented on the touchscreen, selectively applying the second level of voltage to touch sensors configured to detect a touch event in at least a second region of the touchscreen where the user interface objects are not visually presented.

21. The system of claim 14, wherein the touchscreen controller further is configured to initiate executable operations comprising:
identifying a dialog button visually presented in a first region of the touchscreen;
selectively configuring touch sensors configured to detect touch in the first region to exclusively detect a change in current through the first region, wherein the touch sensors configured to detect touch in the first region are selected from a group of touch sensors consisting of the first portion of the plurality of touch sensors and the second portion of the plurality of touch sensors.

22. The system of claim 14, wherein the touchscreen controller further is configured to initiate executable operations comprising:
selectively disabling at least a third portion of the plurality of touch sensors.
